(19) United States
(12) Patent Application Publication
(10) Pub. No.: US 2025/0196688 A1
(43) Pub. Date: Jun. 19, 2025

(54) RANGE EXTENDED ELECTRIFIED VEHICLE DIRECT CURRENT FAST CHARGING CURRENT MANAGEMENT FOR THERMAL PROTECTION

(71) Applicant: FCA US LLC, Auburn Hills, MI (US)

(72) Inventors: Shu Wang, Lake Orion, MI (US); Junkui Huang, Rochester Hills, MI (US)

(21) Appl. No.: 18/538,130

(22) Filed: Dec. 13, 2023

(51) Int. Cl. B60L 53/62; B60K 6/22; B60K 6/26; B60L 53/10; B60L 53/16

(52) U.S. Cl. CPC B60L 53/62; B60K 6/26; B60L 53/11; B60L 53/16; B60K 6/22; B60L 2200/36; B60L 2240/12; B60L 2240/445; B60L 2240/662; B60Y 2200/92

(57) ABSTRACT

A direct current fast charging (DCFC) control system for a range extended electrified vehicle (REEV) includes a set of DCFC connectors electrically connecting a high voltage battery system of an electrified powertrain of the REEV to a charging port of the REEV and a control system configured to determine an ambient temperature external to the REEV, access a temperature model configured to model a temperature associated with the set of DCFC connectors, wherein the temperature model accounts for heat energy generated by an engine of the electrified powertrain, determine, using the temperature model, a modeled temperature associated with the set of DCFC connectors, and control, based on the ambient temperature and the modeled temperature associated with the set of DCFC connectors, a DCFC current provided by an external DCFC station to a high voltage battery system via a charging port and the set of DCFC connectors.

### FIELD

The present application generally relates to range extended electrified vehicles (REEVs) and, more particularly, to techniques for direct current (DC) fast charging current management for thermal protection in REEVs.

### BACKGROUND

Electrified vehicles include electrified powertrains that comprise one or more electric traction motors powered by electrical energy (current) from a high-voltage battery pack or system. Periodic recharging of the battery system is performed via either conventional alternating current (AC) or direct current (DC) charging or newer, higher-voltage DC (“fast”) charging. For electric-only electrified powertrains (e.g., battery electric vehicles, or BEVs), there are a specific set of functional safety considerations for DC fast charging. In range extended electrified vehicles (REEVs), also known as range extended paradigm breakers (REPBs), the electrified powertrain is a hybrid powertrain that includes an internal combustion engine in addition to the one or more electric traction motors.

The engine selectively runs/operates to recharge the high voltage battery system during vehicle operation. For a pickup truck REEV/REPB application capable of towing significant payloads, the engine could often be operating/running at high load conditions, which results in a large amount of heat energy generated by the engine's block and its exhaust system. These high temperature conditions create another potential functional issue for DC fast charging connectors (connecting the high voltage battery system to an external charging port) and the high DC currents flowing therethrough. Accordingly, while such conventional DC fast charging control systems do work well for their intended purpose, there exists an opportunity for improvement in the relevant art.

### SUMMARY

According to one example aspect of the invention, a direct current fast charging (DCFC) control system for a range extended electrified vehicle (REEV) is presented. In one exemplary implementation, the DCFC control system comprises a set of DCFC connectors electrically connecting a high voltage battery system of an electrified powertrain of the REEV to a charging port of the REEV, wherein the electrified powertrain includes one or more electric motors powered by the high voltage battery system and an internal combustion engine, and a control system configured to determine an ambient temperature external to the REEV, access a temperature model configured to model a temperature associated with the set of DCFC connectors, wherein the temperature model accounts for heat energy generated by the engine, determine, using the temperature model, a modeled temperature associated with the set of DCFC connectors, and control, based on the ambient temperature and the modeled temperature associated with the set of DCFC connectors, a DCFC current provided by an external DCFC station to the high voltage battery system via the charging port and the set of DCFC connectors.

In some implementations, the control system is further configured to determine a modeled temperature of air surrounding the set of DCFC connectors by determining, using the temperature model, an initial modeled temperature of the air surrounding the set of DCFC connectors based on at least some of a set of operating parameters of the REEV, determining a cooldown time of the air surrounding the set of DCFC connectors based on the ambient temperature and at least some of the set of operating parameters of the REEV, and determining the modeled temperature of the air surrounding the set of DCFC connectors based on the initial modeled temperature and the cooldown time of the air surrounding the set of DCFC connectors. In some implementations, the modeled temperature associated with the set of DCFC connectors is the modeled temperature of the air surrounding the set of DCFC connectors, and the control system is configured to control the DCFC current by limiting the DCFC current based on the modeled temperature of the air surrounding the set of DCFC connectors. In some implementations, the set of operating parameters of the REEV includes an engine coolant temperature.

In some implementations, the modeled temperature associated with the set of DCFC connectors is a modeled temperature of the set of DCFC connectors, and the control system is configured to control the DCFC current by limiting the DCFC current based on the modeled temperature of the set of DCFC connectors. In some implementations, the control system is further configured to determine, using the temperature model, the modeled temperature of the set of DCFC connectors based on the modeled temperature of the air surrounding the set of DCFC connectors and a set of electrical parameters of the set of DCFC connectors. In some implementations, the set of operating parameters of the REEV includes a power generated by a motor-generator unit (MGU) coupled to the engine and a speed of the REEV. In some implementations, the control system is further configured to trigger a functional safety function of the REEV when the modeled temperature of the set of DCFC connectors exceeds a functional safety thermal limit. In some implementations, the REEV has a pickup truck configuration and is configured to tow or haul a significant additional payload thereby resulting in substantial usage of the engine.

According to another example aspect of the invention, a DCFC control method for an REEV is presented. In one exemplary implementation, the DCFC control method comprises determining, by a control system of the REEV, an ambient temperature external to the REEV, accessing, by the control system, a temperature model configured to model a temperature associated with the set of DCFC connectors, wherein the set of DCFC connectors electrically connect a high voltage battery system of an electrified powertrain of the REEV to a charging port of the REEV, wherein the electrified powertrain includes one or more electric motors powered by the high voltage battery system and an internal combustion engine, and wherein the temperature model accounts for heat energy generated by the engine, determining, by the control system and using the temperature model, a modeled temperature associated with the set of DCFC connectors, and controlling, by the control system and based on the ambient temperature and the modeled temperature associated with the set of DCFC connectors, a DCFC current provided by an external DCFC station to the high voltage battery system via the charging port and the set of DCFC connectors.

In some implementations, the method further comprises determining, by the control system, a modeled temperature of air surrounding the set of DCFC connectors by determining, using the temperature model, an initial modeled temperature of the air surrounding the set of DCFC connectors based on at least some of a set of operating parameters of the REEV, determining a cooldown time of the air surrounding the set of DCFC connectors based on the ambient temperature and at least some of the set of operating parameters of the REEV, and determining the modeled temperature of the air surrounding the set of DCFC connectors based on the initial modeled temperature and the cooldown time of the air surrounding the set of DCFC connectors. In some implementations, the modeled temperature associated with the set of DCFC connectors is the modeled temperature of the air surrounding the set of DCFC connectors, and the control system is configured to control the DCFC current by limiting the DCFC current based on the modeled temperature of the air surrounding the set of DCFC connectors. In some implementations, the set of operating parameters of the REEV includes an engine coolant temperature.

In some implementations, the modeled temperature associated with the set of DCFC connectors is a modeled temperature of the set of DCFC connectors, and the control system is configured to control the DCFC current by limiting the DCFC current based on the modeled temperature of the set of DCFC connectors. In some implementations, the control system is further configured to determine, using the temperature model, the modeled temperature of the set of DCFC connectors based on the modeled temperature of the air surrounding the set of DCFC connectors and a set of electrical parameters of the set of DCFC connectors. In some implementations, the set of operating parameters of the REEV includes a power generated by an MGU coupled to the engine and a speed of the REEV. In some implementations, the control system is further configured to trigger a functional safety function of the REEV when the modeled temperature of the set of DCFC connectors exceeds a functional safety thermal limit. In some implementations, the REEV has a pickup truck configuration and is configured to tow or haul a significant additional payload thereby resulting in substantial usage of the engine.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a range extended electrified vehicle (REEV) having an example direct current fast charging (DCFC) control system according to the principles of the present application;

FIG. 2A is a functional block diagram of a first example architecture for the DCFC control system according to the principles of the present application;

FIG. 2B is a flow diagram of a first example DCFC control method for an REEV based on modeled temperature of air surrounding DCFC connector(s) according to the principles of the present application;

FIG. 3A is a functional block diagram of a second example architecture for the DCFC control system according to the principles of the present application;

FIG. 3B is a flow diagram of a second example DCFC control method for an REEV based on modeled temperature of DCFC connector(s) according to the principles of the present application; and

FIGS. 4A-4F depict example plots corresponding to the first/second DCFC control methods for the REEV according to the principles of the present application.

### DESCRIPTION

As previously discussed, in electric-only electrified powertrains (e.g., battery electric vehicles, or BEVs), there are a specific set of functional safety considerations for direct current (DC) fast charging (hereinafter, “DCFC”). In range extended electrified vehicles (REEVs), also known as range extended paradigm breakers (REPBs), the electrified powertrain is a hybrid powertrain that includes an internal combustion engine in addition to one or more electric traction motors. The engine selectively runs/operates to recharge the high voltage battery system during vehicle operation. For a pickup truck REEV/REPB application capable of towing significant payloads, the engine could often be operating/running at high load conditions, which results in a large amount of heat energy generated by the engine's block and its exhaust system. These high temperature conditions create another potential functional safety issue for DCFC connectors (connecting the high voltage battery system to an external charging port) and the high DC currents flowing therethrough.

Accordingly, improved DCFC control systems and methods for REEV/REPB vehicles are presented herein. These techniques limit the DCFC current according to one of two strategies. In a first (conservative/steady-state) strategy, maximum/worst case current limits are utilized based on a modeled air temperature surrounding the DCFC connectors. In a second (more accurate/transient) strategy, DCFC current is reduced/limited to cool down the DCFC connectors within thermal limits based on estimated temperatures of the DCFC connectors themselves. The DCFC connector temperature is estimated based on the modeled surrounding air temperature and the current flowing therethrough. Because the first strategy is easier to implement and is more conservative, it may be the preferred solution of the two strategies. The second strategy, however, also performs well and, as will be described in greater detail herein, could be more accurate, particularly for transient conditions.

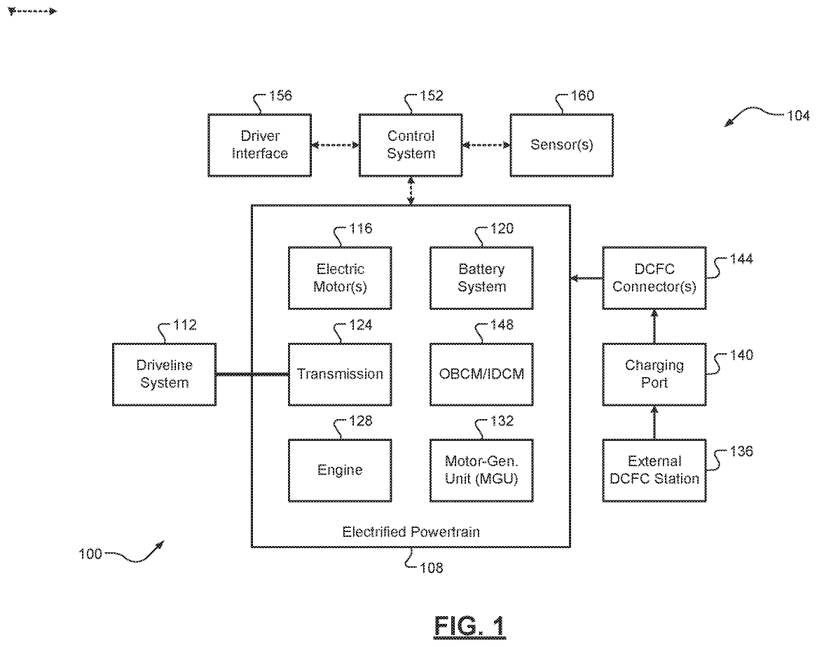

Referring now to FIG. 1, a functional block diagram of an example REEV or REPB 100 (also referred to as “electrified vehicle 100” or “vehicle 100” herein) including a DCFC control system 104 according to some implementations of the present application is presented. In one exemplary implementation, the REEV/REPB 100 is a pickup truck capable of towing/hauling a significant payload. The vehicle 100 generally comprises an electrified powertrain 108 configured to generate and transfer drive torque to a driveline system 112 for vehicle propulsion. The electrified powertrain 108 includes one or more electric traction motors 116 powered by electrical energy (current) supplied by a high voltage (e.g., ˜400 volts DC, or VDC) battery pack or system 120. The electric traction motor(s) 116 generate drive torque that is transferred to the driveline system 112 via a transmission 124, such as a multi-speed automatic transmission. The electrified powertrain 108 also includes an internal combustion engine 128 configured to combust a mixture of air and liquid fuel (diesel, gasoline, etc.) to generate torque that powers a motor-generator unit (MGU) 132. The MGU 132 converts the kinetic (mechanical) energy at the engine 128 (e.g., a flywheel or crankshaft) to electrical energy (current) that is output therefrom and utilized, for example, to recharge the high voltage battery system 120.

The high voltage battery system 120 is also rechargeable using an external DCFC station 136 (e.g., rated at ˜800 VDC or ˜1200 VDC). This external DCFC station 136 is a separate/standalone unit or system (e.g., along a roadside or in a parking lot) and is connectable to the vehicle 100 (and more specifically, the high voltage battery system 120) via a respective charging port 140 and a set of one or more DCFC cables or connectors 144. An integrated dual charging module (IDCM) or onboard charging module (OBCM), herein referred to as “charging module 148,” interfaces between the vehicle 100 and the external DC fast charging station 136 to control DCFC operations therebetween. A control system 152 (e.g., a hybrid control processor, or HCP) of the vehicle 100 controls or oversees all control aspects of the vehicle 100, including controlling the electrified powertrain 108 to generate an amount of drive torque to satisfy a driver torque request received via a driver interface 156 (e.g., an accelerator pedal). The control system 152 could also be configured to control the DCFC operations.

The vehicle 100 also includes a set of sensors 160 configured to measure various parameters such as speeds/pressures/temperatures of various components of the vehicle 100. Non-limiting examples of these measured/monitored parameters include powertrain/driveline shaft (engine/vehicle speed, MGU power, etc.) parameters, hydraulic fluid or oil pressure, engine coolant or oil temperature, and vehicle ambient temperature (i.e., external/outside of the vehicle 100). It will be appreciated that these are merely examples of the sensors 160 and that the sensors 160 could include a variety of other types of sensors, such as a connection sensor for the charging port 140, a state of charge (SOC) sensor for the battery system 120, and electrical parameter (current, voltage, etc.) sensors for the various components described herein (e.g., current flowing through the DCFC connectors 144). Some of these described parameters could also be modeled, such as using models with other parameters as inputs. One specific temperature model that could be utilized models an air temperature surrounding the DCFC connectors 144 (based on operating conditions of the engine 128 and the vehicle ambient temperature).

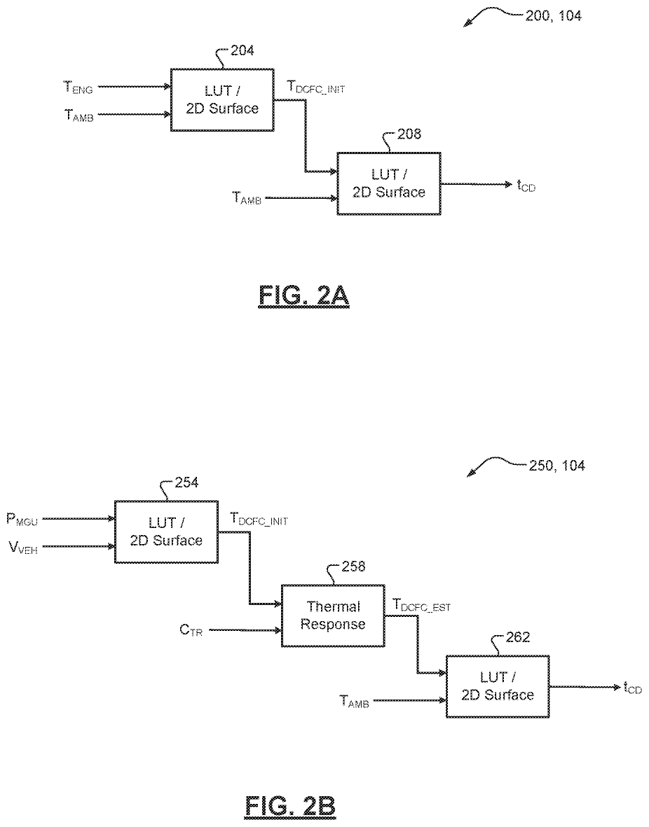

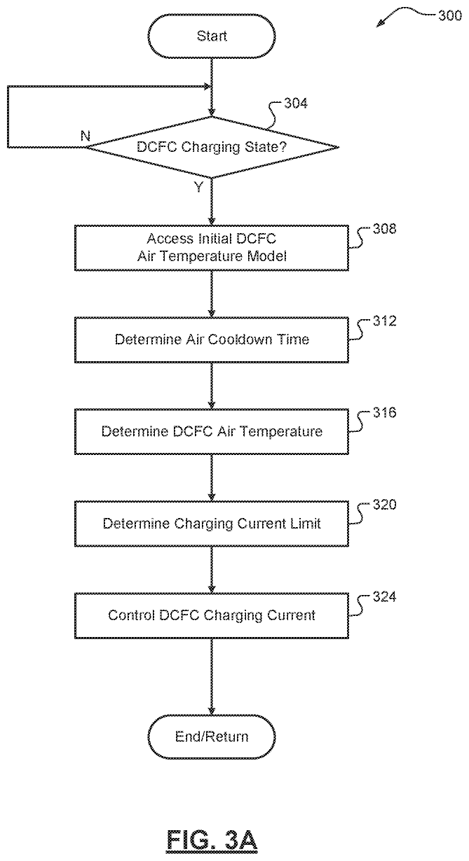

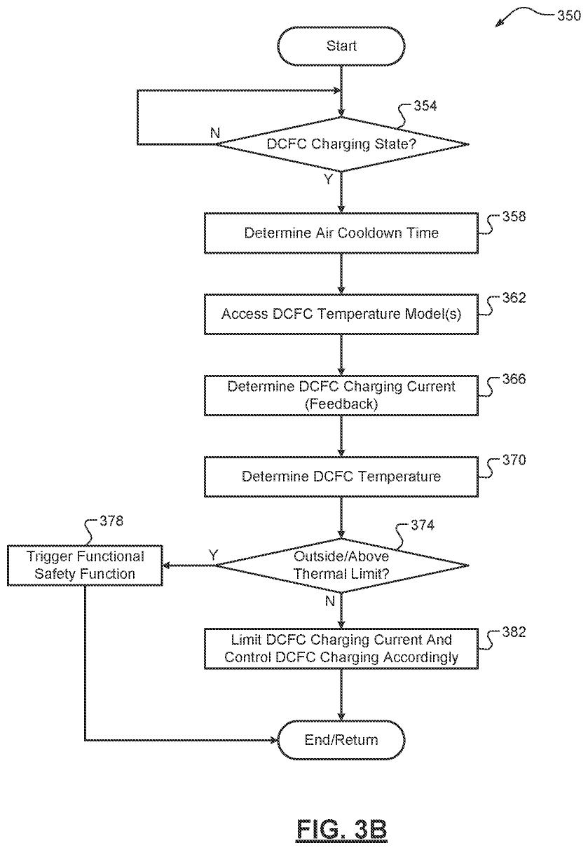

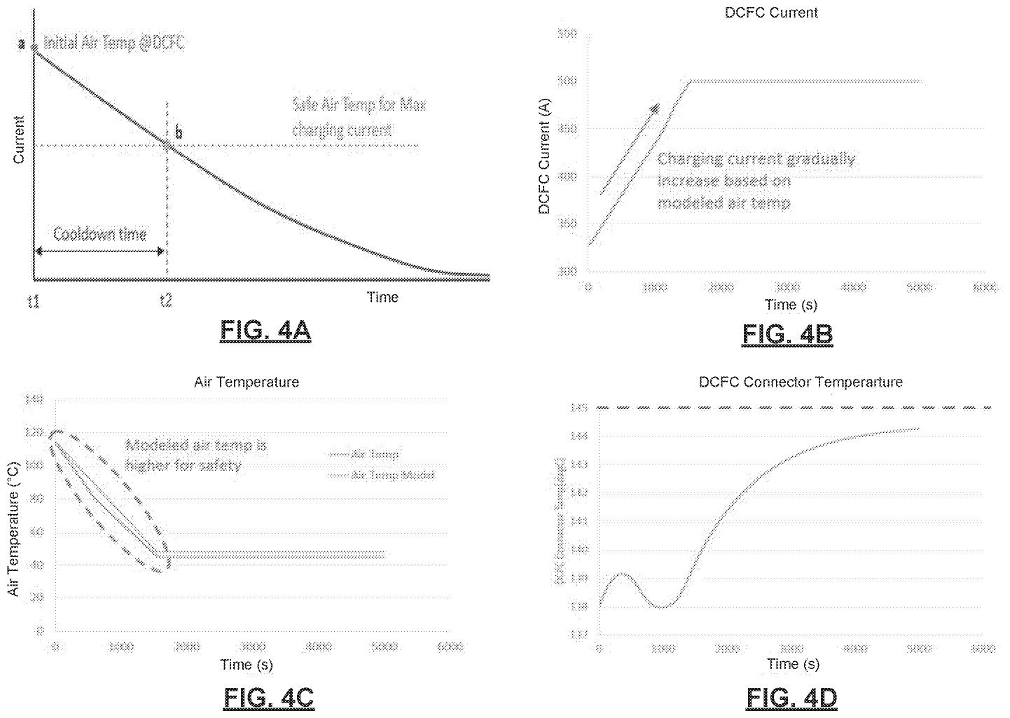

Referring now to FIGS. 2A and 3A, a functional block diagram of a first example architecture 200 for the DCFC control system 104 and a flow diagram of a first example DCFC control method 300 for an REEV according to the principles of the present application are illustrated. In the first example architecture 200, a first look-up table (LUT) or two-dimensional (2D) surface 204 is configured to receive an engine temperature parameters (T_{ENG}) and the ambient temperature (T_{AMB}) and, based thereon, output an initial temperature of air surrounding the DCFC connectors 144 (shown as T_{DCFC_INIT}). This modeled temperature T_{DCFC_INIT} is input to another LUT/surface 208 along with the ambient temperature T_{AMB}, which then outputs a cooldown time (t_{CD}). The LUTs/surfaces 204, 208 could be calibrated using the temperature model(s) discussed herein and thus could represent modeled temperatures. This cooldown time t_{CD} is used, in conjunction with the initial modeled air temperature surrounding the DCFC connectors 144, to determine a final modeled temperature of the air surrounding the DCFC connectors 144 (which is inferred or assumed here to be the temperature of the DCFC connectors 144 themselves).

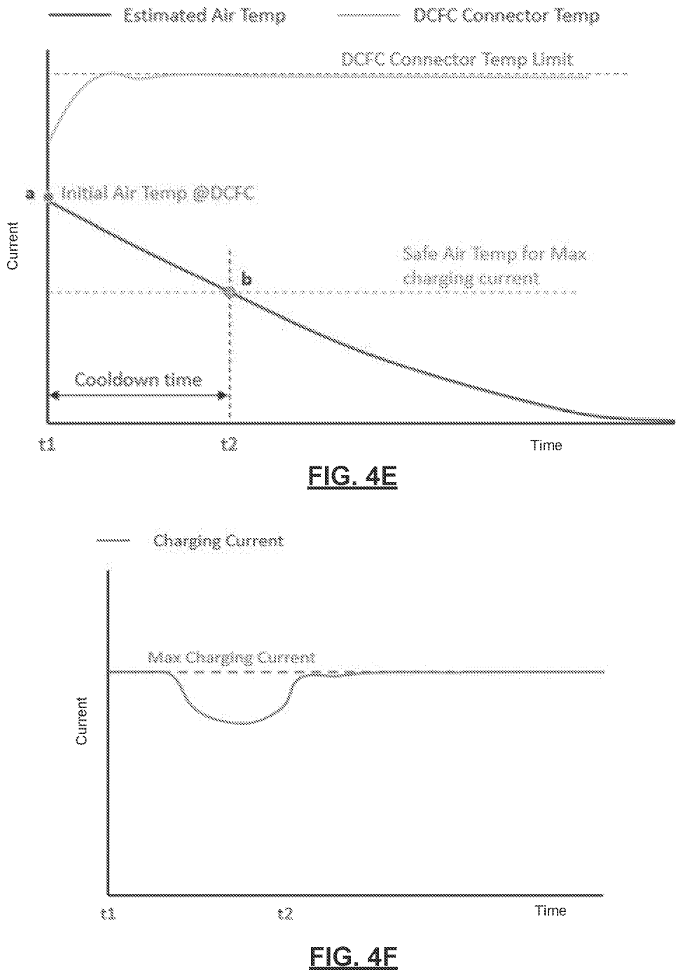

FIG. 3A depicts the flow diagram of the first example DCFC control method 300 for an REEV according to the principles of the present application in greater detail. While the REEV 100 and its components are specifically referenced, it will be appreciated that the method 300 could be applicable to any suitable REEV/REPB vehicle. At 304, the control system 152 determines whether the DCFC charging state is detected. This could be, for example, when a connection is detected at the charging port 140. When false, the method 300 ends or returns to 304. When true, the method 300 proceeds to 308. At 308, the control system 152 accesses an initial DCFC air temperature model (e.g., FIG. 2A). At 312, the control system 152 determines the cooldown time t_{CD}. At 316, the control system 152 determines the final (modeled) temperature of the air surrounding the DCFC connectors 144. At 320, the control system 152 determines a charging limit for the DCFC current (e.g., using a predetermined LUT calibrated for maximum/worst-case scenarios). At 324, the control system 152 controls the DCFC current (from the external DCFC station 136 to the battery system 120 via the charging port 140 and the DCFC connectors 144) based on the charging limit. The method 300 then ends. Examples plots for this method 300 are illustrated in FIGS. 4A-4D.

Referring now to FIG. 2B, a functional block diagram of a second example architecture 250 for the DCFC control system 104 and a flow diagram of a second example DCFC control method 350 for an REEV according to the principles of the present application are illustrated. In the second example architecture 250, a first LUT or 2D surface 254 is configured to receive an engine/MGU power parameter (P_{MGU}) and the vehicle velocity or speed (V_{VEH}) and, based thereon, output an initial temperature of air surrounding the DCFC connectors 144 (shown as T_{DCFC_INIT}). This modeled temperature T_{DCFC_INIT} is input to another LUT/surface 258 along with thermal response coefficient (C_{TR}), which then outputs an estimated temperature of the DCFC connectors 144 (shown as T_{DCFC_EST}). This estimated temperature T_{DCFC_EST} is input to yet another LUT/surface 262 along with the ambient temperature T_{AMB}, which then outputs the cooldown time t_{CD}. The LUTs/surfaces 254, 258, 262 could be calibrated using the temperature model(s) discussed herein and thus could represent modeled temperatures. This cooldown time t_{CD} is used, in conjunction with an initial modeled temperature of the DCFC connectors 144 (i.e., based on surrounding air temperature and current flowing therethrough), to determine a final modeled temperature of the DCFC connectors 144.

FIG. 3B depicts the flow diagram of the second example DCFC control method 350 for an REEV according to the principles of the present application in greater detail. While the REEV 100 and its components are specifically referenced, it will be appreciated that the method 350 could be applicable to any suitable REEV/REPB vehicle. At 354, the control system 152 determines whether the DCFC charging state is detected. This could be, for example, when a connection is detected at the charging port 140. When false, the method 300 ends or returns to 354. When true, the method 350 proceeds to 358. At 358, the control system 152 determines the cooldown time t_{CD} (e.g., FIG. 2B). At 362, the control system 152 accesses a temperature model for modeling the temperature of the DCFC connectors 144 themselves (i.e., rather than the air surrounding the DCFC connectors 144). At 366, the control system 152 determines the current flowing through the DCFC connectors 144 (e.g., as measured feedback). At 370, the control system 152 determines a modeled temperature of the DCFC connectors 144 (based on the surrounding air temperature, the cooldown time t_{CD}, and the current flowing therethrough). At 374, the control system 152 determines whether the modeled temperature of the DCFC connectors 144 exceeds an upper thermal limit or threshold. When true, the method 350 proceeds to 278 where a functional safety feature is triggered (e.g., contactor closing to disable the high voltage electrical system of the REEV 100) and the method 350 then ends. When false, the method 350 proceeds to 382. At 382, the control system 152 controls the DCFC current (from the external DCFC station 136 to the battery system 120 via the charging port 140 and the DCFC connectors 144) based on a charging limit corresponding to the modeled temperature of the DCFC connectors 144. The method 350 then ends. Examples plots for this method 350 are illustrated in FIGS. 4E-4F.

It will be appreciated that the terms “control system” and “controller” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A direct current fast charging (DCFC) control system for a range extended electrified vehicle (REEV), the DCFC control system comprising:
a set of DCFC connectors electrically connecting a high voltage battery system of an electrified powertrain of the REEV to a charging port of the REEV, wherein the electrified powertrain includes one or more electric motors powered by the high voltage battery system and an internal combustion engine; and
a control system configured to:
determine an ambient temperature external to the REEV;
access a temperature model configured to model a temperature associated with the set of DCFC connectors, wherein the temperature model accounts for heat energy generated by the engine;
determine, using the temperature model, a modeled temperature associated with the set of DCFC connectors; and
control, based on the ambient temperature and the modeled temperature associated with the set of DCFC connectors, a DCFC current provided by an external DCFC station to the high voltage battery system via the charging port and the set of DCFC connectors.

2. The DCFC control system of claim 1, wherein the control system is further configured to determine a modeled temperature of air surrounding the set of DCFC connectors by:
determining, using the temperature model, an initial modeled temperature of the air surrounding the set of DCFC connectors based on at least some of a set of operating parameters of the REEV;
determining a cooldown time of the air surrounding the set of DCFC connectors based on the ambient temperature and at least some of the set of operating parameters of the REEV; and
determining the modeled temperature of the air surrounding the set of DCFC connectors based on the initial modeled temperature and the cooldown time of the air surrounding the set of DCFC connectors.

3. The DCFC control system of claim 2, wherein:
the modeled temperature associated with the set of DCFC connectors is the modeled temperature of the air surrounding the set of DCFC connectors; and
the control system is configured to control the DCFC current by limiting the DCFC current based on the modeled temperature of the air surrounding the set of DCFC connectors.

4. The DCFC control system of claim 3, wherein the set of operating parameters of the REEV includes an engine coolant temperature.

5. The DCFC control system of claim 1, wherein:
the modeled temperature associated with the set of DCFC connectors is a modeled temperature of the set of DCFC connectors; and
the control system is configured to control the DCFC current by limiting the DCFC current based on the modeled temperature of the set of DCFC connectors.

6. The DCFC control system of claim 5, wherein the control system is further configured to determine, using the temperature model, the modeled temperature of the set of DCFC connectors based on the modeled temperature of the air surrounding the set of DCFC connectors and a set of electrical parameters of the set of DCFC connectors.

7. The DCFC control system of claim 6, wherein the set of operating parameters of the REEV includes a power generated by a motor-generator unit (MGU) coupled to the engine and a speed of the REEV.

8. The DCFC control system of claim 6, wherein the control system is further configured to trigger a functional safety function of the REEV when the modeled temperature of the set of DCFC connectors exceeds a functional safety thermal limit.

9. The DCFC control system of claim 1, wherein the REEV has a pickup truck configuration and is configured to tow or haul a significant additional payload thereby resulting in substantial usage of the engine.

10. A direct current fast charging (DCFC) control method for a range extended electrified vehicle (REEV), the DCFC control method comprising:
determining, by a control system of the REEV, an ambient temperature external to the REEV;
accessing, by the control system, a temperature model configured to model a temperature associated with the set of DCFC connectors, wherein the set of DCFC connectors electrically connect a high voltage battery system of an electrified powertrain of the REEV to a charging port of the REEV, wherein the electrified powertrain includes one or more electric motors powered by the high voltage battery system and an internal combustion engine, and wherein the temperature model accounts for heat energy generated by the engine;
determining, by the control system and using the temperature model, a modeled temperature associated with the set of DCFC connectors; and
controlling, by the control system and based on the ambient temperature and the modeled temperature associated with the set of DCFC connectors, a DCFC current provided by an external DCFC station to the high voltage battery system via the charging port and the set of DCFC connectors.

11. The DCFC control method of claim 10, further comprising determining, by the control system, a modeled temperature of air surrounding the set of DCFC connectors by:
determining, using the temperature model, an initial modeled temperature of the air surrounding the set of DCFC connectors based on at least some of a set of operating parameters of the REEV;
determining a cooldown time of the air surrounding the set of DCFC connectors based on the ambient temperature and at least some of the set of operating parameters of the REEV; and
determining the modeled temperature of the air surrounding the set of DCFC connectors based on the initial modeled temperature and the cooldown time of the air surrounding the set of DCFC connectors.

12. The DCFC control method of claim 11, wherein:
the modeled temperature associated with the set of DCFC connectors is the modeled temperature of the air surrounding the set of DCFC connectors; and
the control system is configured to control the DCFC current by limiting the DCFC current based on the modeled temperature of the air surrounding the set of DCFC connectors.

13. The DCFC control method of claim 12, wherein the set of operating parameters of the REEV includes an engine coolant temperature.

14. The DCFC control method of claim 10, wherein:
the modeled temperature associated with the set of DCFC connectors is a modeled temperature of the set of DCFC connectors; and
the control system is configured to control the DCFC current by limiting the DCFC current based on the modeled temperature of the set of DCFC connectors.

15. The DCFC control method of claim 14, wherein the control system is further configured to determine, using the temperature model, the modeled temperature of the set of DCFC connectors based on the modeled temperature of the air surrounding the set of DCFC connectors and a set of electrical parameters of the set of DCFC connectors.

16. The DCFC control method of claim 15, wherein the set of operating parameters of the REEV includes a power generated by a motor-generator unit (MGU) coupled to the engine and a speed of the REEV.

17. The DCFC control method of claim 15, wherein the control system is further configured to trigger a functional safety function of the REEV when the modeled temperature of the set of DCFC connectors exceeds a functional safety thermal limit.

18. The DCFC control method of claim 10, wherein the REEV has a pickup truck configuration and is configured to tow or haul a significant additional payload thereby resulting in substantial usage of the engine.
